(19) United States
(12) Patent Application Publication
(10) Pub. No.: US 2026/0227743 A1
(43) Pub. Date: Aug. 6, 2026

(54) WRISTWATCH BAND LIGHTING SYSTEM

(71) Applicant: Torchlight Outdoor Gear Inc., Walnut Creek, CA (US)

(72) Inventors: Joshua Brian Donohoe, Walnut Creek, CA (US); Courtney Noel Donohoe, Walnut Creek, CA (US)

(21) Appl. No.: 19/178,751

(22) Filed: Apr. 14, 2025

Related U.S. Application Data
(60) Provisional application No. 63/633,981, filed on Apr. 15, 2024.

(51) Int. Cl. G04B 47/00; A44C 5/00; F21S 9/02; F21V 33/00

(52) U.S. Cl. CPC G04B 47/00; A44C 5/0007; F21S 9/02; F21V 33/0008

(57) ABSTRACT

The subject matter of this specification can be embodied in, among other things, a portable lighting accessory apparatus for a wristwatch includes a first wristwatch band section configured to be removably affixed to a wristwatch main body, a lighting assembly configured to be removably affixed to the wristwatch main body and having a battery and a light source configured to emit light through a housing aperture, and a first electrical circuit in electrical communication with the battery and the light source, and a second wristwatch band section configured to be removably affixed to the lighting assembly and configured to be positioned against an outer major housing face of the lighting assembly, and a band aperture arranged proximal to a housing aperture and configured to permit light emitted by the light source to be emitted through the band aperture to provide illumination beyond the second wristwatch band section.

### PRIORITY CLAIM AND CROSS-REFERENCE TO RELATED APPLICATIONS

This application claims priority under 35 U.S.C. § 119(e) to U.S. Provisional Patent Application No. 63/633,981, filed Apr. 15, 2024, which is expressly incorporated by reference herein in its entirety.

### TECHNICAL FIELD

This disclosure relates to a wristwatch with a lighting system that is integrated into a wristwatch band and provides illumination to a desired area while an individual is wearing the wristwatch.

### BACKGROUND

Existing lighting products enable a wide range of indoor, outdoor, and nighttime activities. Electronic lighting is typically provided from fixed installations (e.g., a roof, a wall, or ceiling), where a light source receives electrical power from a fixed, wired power source. Such lighting is useful in illuminating a particular area but lacks the flexibility of a portable lighting source. Portable lighting sources, such as flashlights or lanterns, have been developed to provide illumination in varied locations and situations. However, such lighting sources are not always portable enough for a user to wish to carry with them at all times. In the event that a user needs portable lighting, other physical forms of portable lighting systems are needed.

### SUMMARY

In a first embodiment, a portable lighting accessory apparatus for a wristwatch includes a first wristwatch band section configured to be removably affixed to a wristwatch main body at a first band end and extending to a second band end opposite the first band end, a lighting assembly having a first housing configured to be removably affixed to the wristwatch main body at a first housing end and having an outer major housing face defining a housing aperture, a battery, a light source arranged within the first housing proximal to the housing aperture, the light source configured to emit light through the housing aperture to provide illumination, and a first electrical circuit in electrical communication with the battery and the light source, and a second wristwatch band section configured to be removably affixed to the wristwatch main body at a third band end and extending to a fourth band end opposite the third band end, the second wristwatch band section having an outer major band face, an inner major band face opposite the outer major band face and configured to be positioned against the outer major housing face of the first housing, and a band aperture that: extends from the inner major band face to the outer major band face, is arranged proximal to the housing aperture, and is configured to permit light emitted by the light source to be emitted through the band aperture to provide illumination beyond the second wristwatch band section.

Various embodiments can include some, all, or none of the following features. The lighting assembly can be configured to emit light from the light source substantially perpendicular to the outer major housing face of the first housing. A substantially transparent window can be arranged in one of the housing aperture or a portion of the band aperture. The lighting assembly can include a wristwatch coupler assembly affixed to the first housing end of the first housing and configured to be removably affixed to the wristwatch main body. The lighting assembly can further include a charging interface having a plurality of electrically conductive contacts and an electronic battery charger circuit arranged in electrical communication with the charging interface, wherein the battery is a rechargeable battery, and the electronic battery charger circuit is configured to charge the rechargeable battery based on electrical power received at the charging interface. The first housing can be configured to include the battery and the first electrical circuit. The outer major housing face can have a curvilinear configuration, and the first housing can have an inner major housing face with a curvilinear configuration. The portable lighting accessory apparatus can include a second housing pivotably affixed to a second housing end of the first housing opposite the first housing end, the second housing including a second electrical circuit in electrical communication with the first electrical circuit, a third housing pivotably affixed to the second housing, the third housing including a third electrical circuit in electrical communication with the second electrical circuit, and an electronic battery charger circuit configured to charge the battery and arranged in one of the second housing or the third housing, wherein the battery can be a rechargeable battery. The portable lighting accessory apparatus can include a charging interface including a collection of electrically conductive contacts arranged on one of the first housing, the second housing, or the third housing, and, wherein the electronic battery charger circuit is configured to charge the battery based on electrical power received at the charging interface. The second wristwatch band section can include a curvilinear coupler at the third band end and configured to partly surround the first housing end. The first housing can have at least one housing bore defined therein, and the second wristwatch band section has at least one band bore defined therein and arranged to overlap and align with the housing bore, and the second wristwatch band section can include at least one fastener arranged to extend through the band bore and engage the housing bore.

In another example embodiment, a portable lighting accessory apparatus for a wristwatch includes a first wristwatch band section configured to be removably affixed to a wristwatch main body at a first band end and extending to a second band end opposite the first band end, a lighting assembly having a first link having a first housing adapted to be operatively coupled to the wristwatch main body at a first housing end and having: (i) a first outer major housing face defining a housing aperture and a first inner major housing face opposite the first outer major housing face, (ii) a light source arranged within the first housing proximal to the housing aperture, the light source configured to emit light through the housing aperture to provide illumination, and (iii) a first electrical circuit arranged within the first housing in electrical communication with the light source, a second link operatively coupled to the first link and having a second housing with: (i) a rechargeable battery and (ii) a second electrical circuit arranged at least partly within the second housing and in electrical communication with the rechargeable battery and the first electrical circuit, a third link operatively coupled to the second link and having a third housing with: (i) an electronic battery charger circuit configured to charge the rechargeable battery, (ii) a charging interface, and (iii) a third electrical circuit in electrical communication with the charging interface, the electronic battery charger circuit, and the rechargeable battery, and a second wristwatch band section configured to be removably affixed to the first housing end at a third band end and extending to a fourth band end opposite the third band end, the second wristwatch band section having an outer major band face, an inner major band face opposite the outer major band face and configured to reside against the first housing, and a band aperture that extends from the inner major band face to the outer major band face, is arranged proximal to the housing aperture, and is configured to permit light emitted by the light source to pass through the band aperture to provide illumination beyond the second wristwatch band section.

Various embodiments can include some, all, or none of the following features. The lighting assembly can be configured to emit light from the light source substantially perpendicular to the first outer major housing face of the first housing. The portable lighting accessory apparatus can include a substantially transparent window arranged in one of the housing aperture or a portion of the band aperture. The lighting assembly can include a wristwatch coupler assembly affixed to the first housing end of the first housing and configured to be removably affixed to the wristwatch main body. The first outer major housing face can be configured as a curvilinear outer face, and the first inner major housing face can be configured as a curvilinear inner face. The charging interface can include a collection of electrically conductive contacts arranged on the third housing, wherein the electronic battery charger circuit can be configured to charge the rechargeable battery based on electrical power received at the charging interface. The second wristwatch band section can include a curvilinear coupler at the third band end and configured to partly surround the first housing end. The first housing can have at least one housing bore defined therein, and the curvilinear coupler can have at least one band bore defined therein and arranged to overlap and align with the housing bore, and the second wristwatch band section can include at least one fastener arranged to extend through the band bore and engage the housing bore. The first housing can have at least one housing bore defined therein, and the second wristwatch band section can have at least one band bore defined therein and arranged to overlap and align with the housing bore, and the second wristwatch band section can include at least one fastener arranged to extend through the band bore and engage the housing bore.

The systems and techniques described here may provide one or more of the following advantages. First, the system can provide lighting or other functions with enhanced portability and convenience. Second, the system can provide hands-free lighting. Third, the system can augment existing watches and wristwear with additional functionality. Fourth, the system can provide lighting or other functionality in a form factor that aesthetically integrates with the host device. Fifth, the system can be electrically independent from the host device.

The details of one or more implementations are set forth in the accompanying drawings and the description below. Other features and advantages will be apparent from the description and drawings, and from the claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a perspective view of an example portable lighting accessory apparatus for a wristwatch.

FIG. 2 shows a perspective rear view of the example portable lighting accessory apparatus of FIG. 1.

FIG. 3 shows a partly exploded perspective view of the example portable lighting accessory apparatus of FIG. 1.

FIG. 4 shows a sectional side view of the example portable lighting accessory apparatus of FIG. 1.

FIG. 5 shows a perspective view of another example portable lighting accessory apparatus for a wristwatch.

FIG. 6 shows a perspective rear view of the example portable lighting accessory apparatus of FIG. 5.

FIGS. 7 and 8 show partly exploded perspective views of the example portable lighting accessory apparatus of FIG. 5.

FIG. 9 shows a sectional side view of the example portable lighting accessory apparatus of FIG. 5.

FIG. 10 shows a sectional side view of another embodiment of an example portable lighting accessory apparatus.

While the example portable lighting accessory apparatus will be described in connection with the preferred embodiments shown herein, it will be understood that it is not intended to limit the apparatus to those embodiments. On the contrary, it is intended to cover all alternatives, modifications, and equivalents, as may be included within the spirit and scope of the apparatus as defined by the appended claims.

### DETAILED DESCRIPTION

In the following detailed description, numerous specific details are set forth by way of examples to provide a thorough understanding of the relevant teachings. However, it should be apparent to those skilled in the art that the present teachings may be practiced without such details. In other instances, well-known methods, procedures, components, and/or circuitry have been described at a relatively high level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or components in the Figures may be selectively omitted and/or combined consistent with the disclosed methods and systems. Additionally, one or more steps of the method of assembling the assembly may be performed in a different order. Accordingly, the drawings and detailed description are to be regarded as illustrative in nature, not restrictive or limiting.

In general, this disclosure describes several variants of a wristwatch with a lighting system apparatus that is integrated into a wristwatch band and provides illumination to a desired area while an individual is wearing the wristwatch. In general, the apparatus can be attached and detached like an interchangeable watch strap or band, in which an electronics assembly resembles one or more links of an interlinked watch band. The apparatus is configured as a functionally and electrically independent, stand-alone device that does not require power or communication with the wristwatch to which it is attached, although in some embodiments the accessory apparatus may be in electrically and/or communicatively connected to the wristwatch. Furthermore, the apparatus is configured such that the electronics assembly is at least partly covered by a watch strap, which can enhance the aesthetic appeal of the accessory in addition to its functional appeal.

The description below describes the portable electronic accessory apparatus primarily in the context of a flashlight accessory that can be worn on a user's wrist as a watch band for the user's wristwatch. In general, such flashlight accessories are configured to shine light radially outward (e.g., relative to the wearer's wrist and/or the curvature of the watch band) from the electronics assembly, and the watch band portion that overlies the electronics assembly includes an aperture or window through which the light can shine. However, embodiments of the portable electronic accessory apparatus are not limited to flashlights and can be configured with other and/or additional features and/or functionality, as will be described in more detail below.

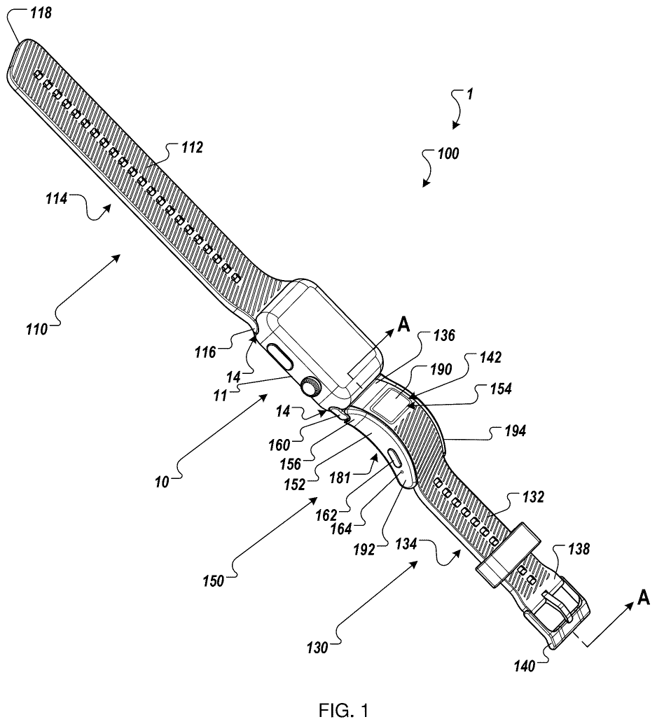

FIG. 1 shows a perspective view of an example portable lighting accessory apparatus 100 for a wristwatch assembly 1 that includes a wristwatch 10. In general, the portable lighting accessory apparatus 100 includes a wristwatch band section 110, a wristwatch band section 130, and an electronics assembly 150 configured as a lighting assembly. The wristwatch band section 110, the wristwatch band section 130, and the electronics assembly 150, collectively, are configured as a removable and interchangeable watch band for the wristwatch 10. In general, the wristwatch band section 130 overlies an outer surface of the electronics assembly 150, connecting to the electronics assembly 150 proximal to where the electronics assembly 150 connects to the wristwatch 10, partly obfuscating the electronics assembly 150 without interfering with the functionality of the electronics assembly 150.

The wristwatch band section 110 has a substantially flat body having an outer major band face 112, an inner major band face 114, and extends from an end 116 to an end 118 opposite the end 116. The wristwatch band section 110 can be made from any appropriate wristwatch band material, such as silicone, rubber, metal (e.g., stainless steel, precious metals), leather, nylon, fabric, ceramic, exotic materials, or combinations of these and/or any other appropriate material.

The end 116 is configured to be removably attached to a main body 11 of the wristwatch 10. In the illustrated example, the end 116 has a watch band retainer feature 14 having a shape that is complimentary to and compatible with a watch band retainer feature of the wristwatch 10. For example, the wristwatch 10 can include a lateral bore having an axial slot, and the end 116 can be defined with a cylindrical bulge that can be slipped laterally into the bore such that the band section 110 extends away from the end 116 through the axial slot. In some embodiments, the end 116 can include a spring bar configured to be removably assembled to corresponding lugs of the wristwatch 10. In some embodiments, the end 116 can include a coupler mechanism, clasp, magnet, fastener, hook, dovetail, or any other form of connection structure that is appropriate for removably affixing watch bands to various brands and models of wristwatches, smartwatches, wrist-worn wearable fitness trackers, and other wrist-worn devices and accessories.

The wristwatch band section 130 has a substantially flat body having an outer major band face 132, an inner major band face 134, and extends from an end 136 to an end 138 opposite the end 136. The wristwatch band section 130 can be made from any appropriate wristwatch band material, such as silicone, rubber, metal (e.g., stainless steel, precious metals), leather, nylon, fabric, ceramic, exotic materials, or combinations of these and/or any other appropriate material. The wristwatch band section 130 includes a buckle 140 configured to couple the end 138 to the wristwatch band section 110 in a loop that can be adjusted to fit a wearer's wrist. The end 136 is configured to be removably attached to the electronics assembly 150, as will be described in more detail below.

The wristwatch band section 130 includes a band aperture 142 defined therethrough from the inner major band face 134 to the outer major band face 132 and arranged proximal to a housing aperture 154 of a housing 152 of the electronics assembly 150. The housing aperture 154 is substantially covered by a substantially transparent window 190 or lens. As will be described in more detail below, the band aperture 142 is configured to permit light emitted by a light source of the electronics assembly 150 to be emitted through the band aperture 142 to provide illumination of nearby objects.

An end 156 of the housing 152 is hingedly affixed to a wristwatch coupler assembly 160. The wristwatch coupler assembly 160 is configured to be removably attached to the main body 11 of the wristwatch 10. In the illustrated example, the wristwatch coupler assembly 160 has a shape that is complimentary to and compatible with a watch band retainer feature 14 of the wristwatch 10. For example, the wristwatch 10 can include a lateral bore having an axial slot, and the wristwatch coupler assembly 160 can be defined with a cylindrical member that can be slipped laterally into the bore such that the wristwatch coupler assembly 160 through the axial slot. In some embodiments, the wristwatch coupler assembly 160 can include a spring bar configured to be removably assembled to corresponding lugs of the wristwatch 10. In some embodiments, the wristwatch coupler assembly 160 can include a coupler mechanism, clasp, magnet, fastener, hook, dovetail, or any other form of connection structure that is appropriate for removably affixing watch bands to various brands and models of wristwatches, smartwatches, wrist-worn wearable fitness trackers, and other wrist-worn devices and accessories.

The electronics assembly 150 includes a button 162 and an indicator 164. The button 162 is configured to control various operational modes of the electronics assembly 150. For example, the button 162 can be pressed to select and/or cycle through various lighting modes (e.g., on, off, high, medium, low, strobe, white, color). The indicator 164 is configured to show various operational states of the electronics assembly 150. For example, the indicator 164 can be illuminated with different colors, brightnesses, steady or blinking patterns, or combinations of these to convey status or state information about the electronics assembly 150 (e.g., on, off, charging, battery level, error, connection status).

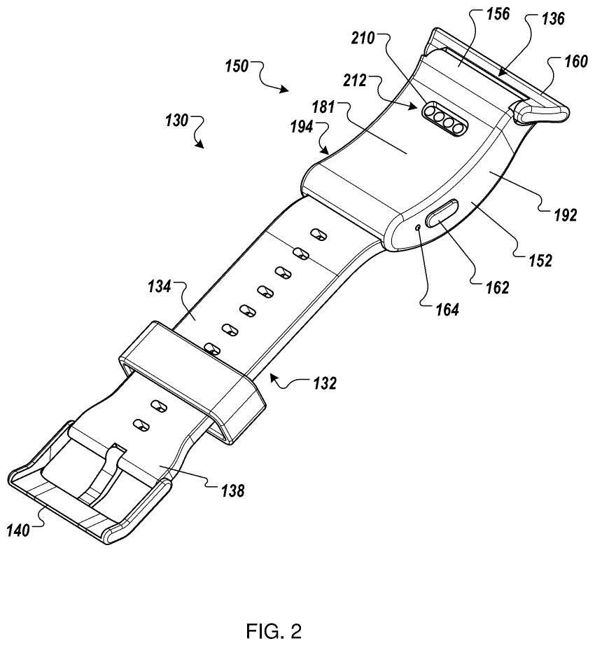

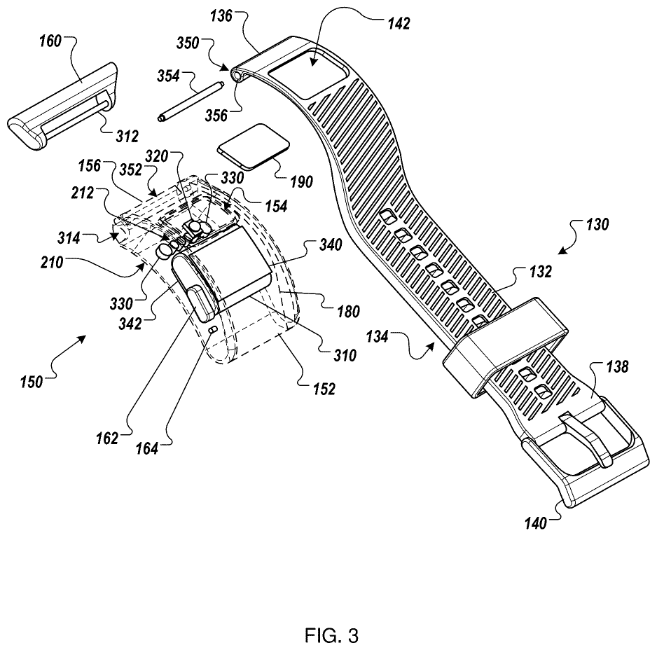

FIG. 2 shows a perspective rear view of the example portable lighting accessory apparatus 100. The electronics assembly 150 includes a charging interface 210 having a collection of electrically conductive contacts 212. In operation, a power interface (not shown) can be electrically coupled to the charging interface 210 to provide powering the electronics assembly 150 or for recharging rechargeable batteries (which will be discussed further in the description of FIG. 3) within the housing 152.

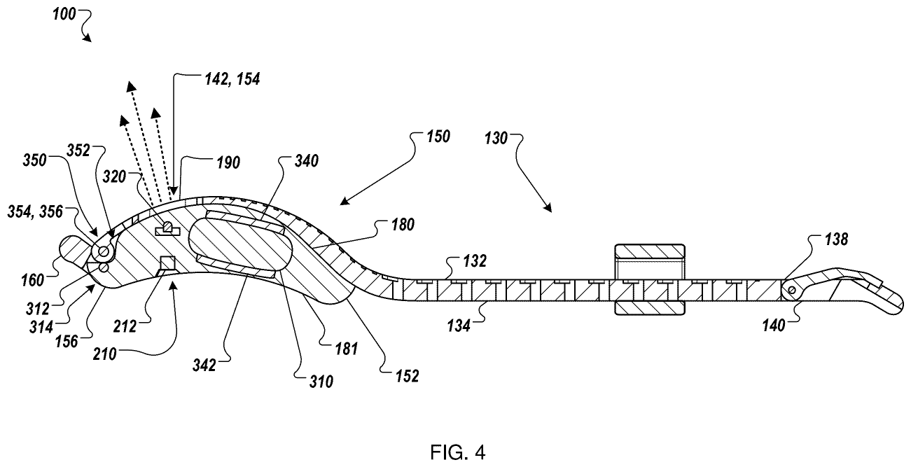

FIG. 3 shows a partly exploded perspective view of the watch band section 130 and the electronics assembly 150 of the example portable lighting accessory apparatus 100. FIG. 4 shows a sectional side view of the watch band section 130 and the example portable lighting accessory apparatus 100 taken along section line A-A of FIG. 1. For the purposes of this description, in FIG. 3 the housing 152 is shown in dashed lines to reveal components within the housing 152.

The housing 152 is a semi-rectangular housing having an outer major housing face 180 defining the housing aperture 154. The substantially transparent window 190 is configured to be arranged within the housing aperture, and can be made from glass, polycarbonate, or any other appropriate substantially transparent material. In some embodiments, the transparent window 190 can be adhered to or sealed against the housing 152 about the housing aperture 154. In some embodiments, the housing 152 can include seals, gaskets, welds, epoxies, or combinations of these and any other appropriate sealing means to make the electronics assembly 150 resistant to incursion by liquids or debris (e.g., providing a standard level of environmental protection, such as IP65, IP67, or IP68).

The electronics assembly 150 includes a battery 310, as well as a light source 320 (e.g., an LED) arranged within the housing 152 proximal to the housing aperture 154. In their assembled form, the light source 320 is configured to emit light through the housing aperture 154 and the window 190 to emit light from the light source 320 substantially perpendicular to the outer major housing face 180 (e.g., and the wearer's wrist) to provide illumination.

The wristwatch coupler assembly 160 is hingedly affixed to the housing end 156 of the housing 152 by a pin 312 and a barrel 314 defined in the housing end 156, to form a pivotable hinge assembly that permits the housing 152 to move relative to the wristwatch coupler assembly 160 and the wristwatch 10. The wristwatch coupler assembly 160 is configured to adapt the portable lighting accessory apparatus 100 to the wristwatch 10. As such, the wristwatch coupler assembly 160 may be configured with a variety of different shapes and couplers that are complimentary to various wristwatch manufacturers'various makes and models of wristwatches. In the illustrated example, the wristwatch 10 includes a lateral bore having an axial slot, and the wristwatch coupler assembly 160 is defined with a cylindrical bulge that can be slipped laterally into the bore such that the wristwatch coupler assembly 160 extends away from the wristwatch 10 through the axial slot. In some embodiments, the wristwatch coupler assembly 160 can include a spring bar configured to be removably assembled to corresponding lugs of the wristwatch 10. In some embodiments, the wristwatch coupler assembly 160 can be configured to slide into a track or channel on one or both sides of the receiving device, and lock in place with friction of a clasp/hook mechanism. In some embodiments, the wristwatch coupler assembly 160 can include a coupler mechanism, clasp, magnet, fastener, hook, dovetail, or any other form of connection structure that is appropriate for removably affixing watch bands to various brands and models of wristwatches, smartwatches, and other wrist-worn devices and accessories (e.g., Apple Watch Band Interface connection, Garmin watches'Quick Release system, Samsung Galaxy Watch models with spring bar attachment system, Google Fitbit and Pixel Watch models with spring-loaded pin mechanisms and/or Active Bands, wearable fitness trackers).

Arranged within the electronics assembly 150 are the light source 320 (e.g., an LED, SMD light, COB light), the battery 310, and an electrical circuit 340 in electrical communication with the battery 310, the light source 320, the button 162, and the indicator 164. In some embodiments, the battery 310 can be a rechargeable polymer battery rated for about 3.7V at about 30 mAh, 60 mAh, 90 mAh, 110 mAh or more.

The electrical circuit 340 is configured to detect user input (e.g., presses) of the button 162 to control the flow of power from the battery 310 to the light source 320 to provide illumination. The electrical circuit 340 can be configured to respond to user input at the button 162 to control various operational states of the light source 320, such as to turn the light source 320 on and off, to select brightness modes (e.g., high, medium, low), flashing or strobing effects, color temperature and/or hue (e.g., red mode), or combinations of these or any other appropriate light setting. In some embodiments, the electrical circuit 340 can be configured to recognize different durations and patterns of button presses as different user commands. For example, a long press can be used to turn the light on and off, and short presses can cycle the light among full (e.g., 100%), high (e.g., ~75%), medium (e.g., ~50%), and low (e.g., ~25%) brightnesses. In some embodiments, the light source 320 can provide between 1 and 1000 lumens, or between 1 and 600 lumens, or between 1 and 100 lumens, or between 1 and 60 lumens. In another example, the button 162 can be pressed to switch the light into a red (e.g., low light, low glare) mode having one or more brightness levels.

In some embodiments, power consumption by the light source 320 can be substantially proportional or related to the selectable brightness level, in which lower brightnesses may be selected to provide longer durations of illumination, while higher brightness levels may be selected to provide additional illumination in exchange for shorter runtimes. For example, the electronics assembly 150 can be configured to operate in a 100% brightness output mode (e.g., about 50-100 Lumens) for about 1 hour and 15 minutes, operate in a 75% brightness mode (e.g., about 35-50 Lumens) for about 1 hour and 30 minutes, operate in a 50% brightness mode (e.g., about 20-35 Lumens) for about 2 hours and 30 minutes, operated in a 25% brightness mode (e.g., about 5-20 Lumens) for about 5 hours, operate in a red light mode (e.g., illuminate red at about 5 -15 Lumens) for about 12 hours, and/or operate in a strobe mode (e.g., flash with a brightness of about 50-70 Lumens) for about 2 hours.

.Since the electronics assembly 150 is electrically independent from the wristwatch 10, use of the light source 320 that exhausts the battery 310 will have substantially no effect on the battery of wristwatch 10 (if present). Furthermore, since the electronics assembly 150 is electrically independent from the wristwatch 10, the example portable lighting accessory apparatus 100 can be used with mechanical wristwatches as well as electronic wristwatches.

The electrical circuit 340 is also configured to illuminate the indicator 164, for example, to convey operational status information about the portable lighting accessory apparatus 100, such as on/off status, battery status, charging status, or combinations of these and any other appropriate status information for the electrical circuit 340. For example, the indicator 164 can be controlled to illuminate green when the battery 310 capacity is between 100% and 66%, illuminate yellow from 65% down to 34%, and illuminate red between 33% and 1%.

Visible in the view provided by FIG. 3 is the collection of electrically conductive contacts 212 that are exposed at the charging interface 210. The electrically conductive contacts 212 are in electrical communication with the electrical circuit 340, and the electrical circuit 340 includes an electronic battery charger circuit 342 configured to charge the battery 310 based on electrical power received at the electrically conductive contacts 212 of the charging interface 210. In some embodiments, the electronic battery charger circuit 342 may be configured to charge the battery 310 based on other recharging techniques.

For example, the electronic battery charger circuit 342 can include an inductive charging antenna and be configured to recharge the battery 310 using power received from an inductive charging coil (e.g., a wireless charger). In another example, the electrical circuit 340 can be configured for kinetic charging, in which kinetic energy (e.g., movement of the wearer's wrist) can be converted into electrical energy that can be stored in the battery 310. In yet another example, the electrical circuit 340 can be configured to receive electrical energy from a photovoltaic cell (e.g., solar panel) arranged on the portable lighting accessory apparatus 100. In yet another example, the electrical circuit 340 can include a thermoelectric generator configured to convert the user's body heat into electrical power to recharge the battery 310. In yet another example, the electrically conductive contacts 212 can be configured as a plug or socket (e.g., a USB-C charging receptacle). In the illustrated example, the battery 310 is a rechargeable battery, but in some embodiments the battery 310 may be a non-rechargeable (e.g., replaceable, disposable) battery.

The housing 152 includes a collection of magnets 330 arranged proximal to the collection of electrically conductive contacts 212 and the charging interface 210. In use, the magnets 330 help to align and removably couple (e.g., snap into place) the electrically conductive contacts 212 to a power interface (not shown) having complementary magnets or magnetic components and configured to provide power for recharging the battery 310.

The wristwatch band section 130 is configured to be overlaid upon the housing 152, such that the inner major band face 134 opposite the outer major band face 132 is layered upon the outer major housing face 180. When the wristwatch band section 130 is overlaid upon the housing 152, the band aperture 142 is substantially aligned with the housing aperture 154 and the transparent window 190. In some embodiments, the transparent window 190 may extend radially away from the housing aperture 154 and extend at least partly into or through the band aperture 142.

The wristwatch band section 130 includes a coupler 350 at the end 136, and the housing 152 defines a recess 352 having a shape that is complementary to the outer shape of the coupler 350. The coupler 350 is configured to partly surround the end 136, by partly wrapping over a portion of the end 136 into the recess 352. The wristwatch band section 130 is hingedly affixed to the housing end 156 of the housing 152 by a pin 354 and a barrel 356 defined in the end 136, to form a pivotable hinge assembly that permits the wristwatch band section 130 to move relative to the electronics assembly 150. In some embodiments, the pin 354 can be a spring pin that permits tool-free release of the pin 354 from the housing 152 and removal replacement of the wristwatch band section 130 from the electronics assembly 150.

In some embodiments, the wristwatch band sections 110 and 130 can be user replaceable. For example, the wristwatch band section 130 can be separated from the electronics assembly 150 and exchanged for a replacement wristwatch band section 130 due to wear. In another example, the wristwatch band sections 110 and 130 can be removable to enable the wearer to easily change the appearance of the portable lighting accessory apparatus 100, such as by having a nylon or silicone watch band to wear for workouts, a leather band to wear for work, and a gold-plated band to wear for formal events.

As best shown in FIG. 4, the outer major housing face 180 is configured as a curvilinear outer face, and the housing 152 has an inner major housing face 181 configured as a curvilinear inner face opposite the outer major housing face 180. Referring again to FIG. 1, a lateral face 192 extends substantially from the inner major housing face 181 to the outer major housing face 180, and another lateral face 194 extends substantially from the inner major housing face 181 to the outer major housing face 180 opposite the lateral face 192. In general, the housing 152 has a curvature that compliments the natural shape of a human wrist and swings radially relative to the wristwatch 10 such that the electronics assembly can partly conform to the shape and size of the wearer to provide a comfortable fit and a sleek appearance when worn. In some embodiments, the housing 152 can be formed in a variety of sizes and shapes (e.g., radius of curvature) to accommodate different wearers and different-sized wrists. For example, a small/medium size housing could be provided to fit wrists from about 130 mm to about 180 mm in circumference, while a medium/large size housing could be provided to fit wrists from about 160 mm to about 210 mm or larger in circumference. The interchangeability provided by the wristwatch band sections 110 and 130 can further enhance the comfort and appearance of the portable lighting accessory apparatus 100 by enabling the user to change the look and feel of the wristwatch band sections 110 and 130 as desired.

While the portable lighting accessory apparatus 100 is described above to have the electronics assembly 150 configured as a single link, in some embodiments the electronics assembly 150 can be modified to distributed various components and functions of the electronics assembly 150 across a mechanically and electrically interconnected chain of links. For example, the light source 320 can be arranged in one link and the battery 310 can be arranged in another link. Various embodiments of the portable lighting accessory apparatus 100 can include two, three, four, five, ten, twenty, or any other appropriate number of active and/or passive links.

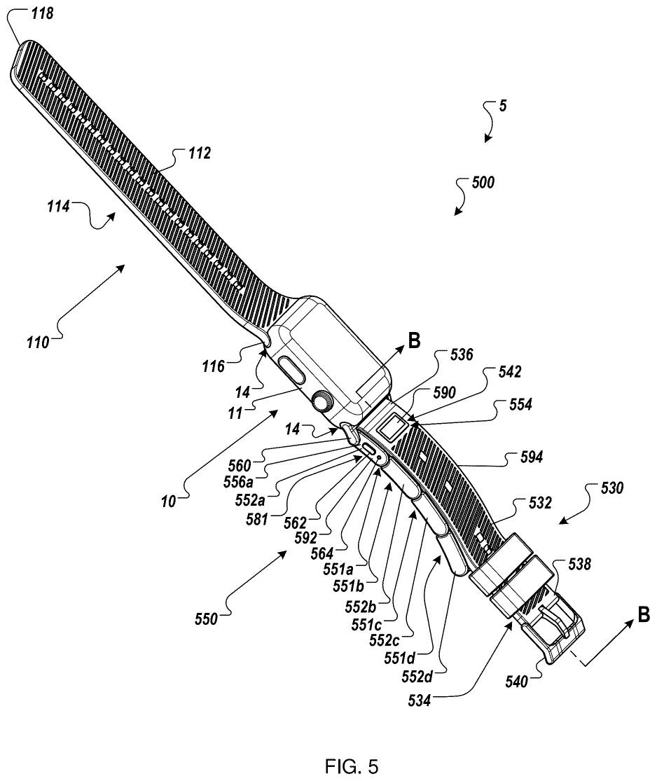

FIG. 5 shows a perspective view of another example portable lighting accessory apparatus 500 for a wristwatch assembly 5 that includes the wristwatch 10. In general, the portable lighting accessory apparatus 500 includes the wristwatch band section 110, a wristwatch band section 530, and an electronics assembly 550 configured as a lighting assembly. In general, the portable lighting accessory apparatus 500 is substantially similar in functionality to the example portable lighting accessory apparatus 100 of FIGS. 1-4, but in the portable lighting accessory apparatus 500 is configured as a collection of hingedly and electrically interconnected links (e.g., wristwatch band links) that includes a link 551a, a link 551b, a link 551c, and a link 551d.

The wristwatch band section 110, the wristwatch band section 530, and the electronics assembly 550, collectively, are configured as a removable and interchangeable watch band for the wristwatch 10. In general, the wristwatch band section 530 overlies an outer surface of the electronics assembly 550 and the links 551a-551d, connecting to the link 551a proximal to where the link 551a connects to the main body 11 of the wristwatch 10, partly obfuscating the electronics assembly 550 without interfering with the functionality of the electronics assembly 550.

The wristwatch band section 530 has a substantially flat body having an outer major band face 532, an inner major band face 534, and extends from an end 536 to an end 538 opposite the end 536. The wristwatch band section 530 can be made from any appropriate wristwatch band material, such as silicone, rubber, metal (e.g., stainless steel, precious metals), leather, nylon, fabric, ceramic, exotic materials, or combinations of these and/or any other appropriate material. The wristwatch band section 530 includes a buckle 540 configured to couple the end 538 to the wristwatch band section 110 in a loop that can be adjusted to fit a wearer's wrist. The end 536 is configured to be removably attached to the electronics assembly 550, as will be described in more detail below.

The wristwatch band section 530 includes a band aperture 542 defined therethrough from the inner major band face 534 to the outer major band face 532 and arranged proximal to a housing aperture 554 of a housing 552a of the link 551a. The housing aperture 554 is substantially covered by a substantially transparent window 590. As will be described in more detail below, the band aperture 542 is configured to permit light emitted by a light source of the electronics assembly 550 to be emitted through the band aperture 542 to provide illumination of nearby objects.

An end 556a of the housing 552a is hingedly affixed to a wristwatch coupler assembly 560. The wristwatch coupler assembly 560 is configured to be removably attached to the wristwatch 10. In the illustrated example, the wristwatch coupler assembly 560 has a shape that is complimentary to and compatible with the watch band retainer feature 14 of the wristwatch 10. For example, the wristwatch 10 can include a lateral bore having an axial slot, and the wristwatch coupler assembly 560 can be defined with a cylindrical member that can be slipped laterally into the bore such that the wristwatch coupler assembly 560 through the axial slot. In some embodiments, the wristwatch coupler assembly 560 can be configured to slide into a track or channel on one or both sides of the receiving device, and lock in place with friction of a clasp/hook mechanism. In some embodiments, the wristwatch coupler assembly 560 can include a spring bar configured to be removably assembled to corresponding lugs of the wristwatch 10. In some embodiments, the wristwatch coupler assembly 560 can include a coupler mechanism, clasp, magnet, fastener, hook, dovetail, or any other form of connection structure that is appropriate for removably affixing watch bands to various brands and models of wristwatches, smartwatches, wrist-worn fitness trackers, and other wrist-worn devices and accessories.

The link 551a includes a button 562 and an indicator 564. The button 562 is configured to control various operational modes of the electronics assembly 550. For example, the button 562 can be pressed to select and/or cycle through various lighting modes (e.g., on, off, high, medium, low, strobe, white, color). The indicator 564 is configured to show various operational states of the electronics assembly 550. For example, the indicator 564 can be illuminated with different colors, brightnesses, steady or blinking patterns, or combinations of these to convey status or state information about the electronics assembly 550 (e.g., on, off, charging, battery level, error, connection status).

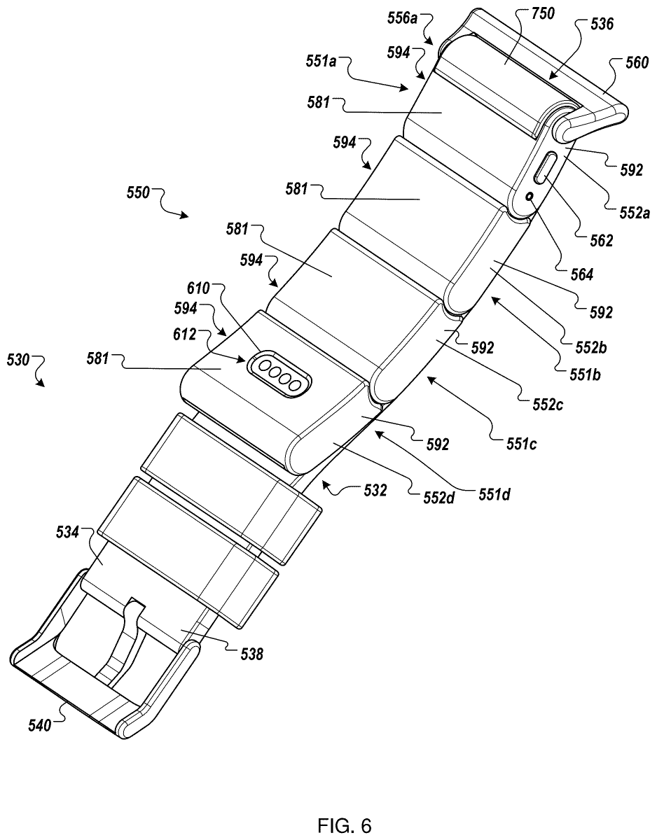

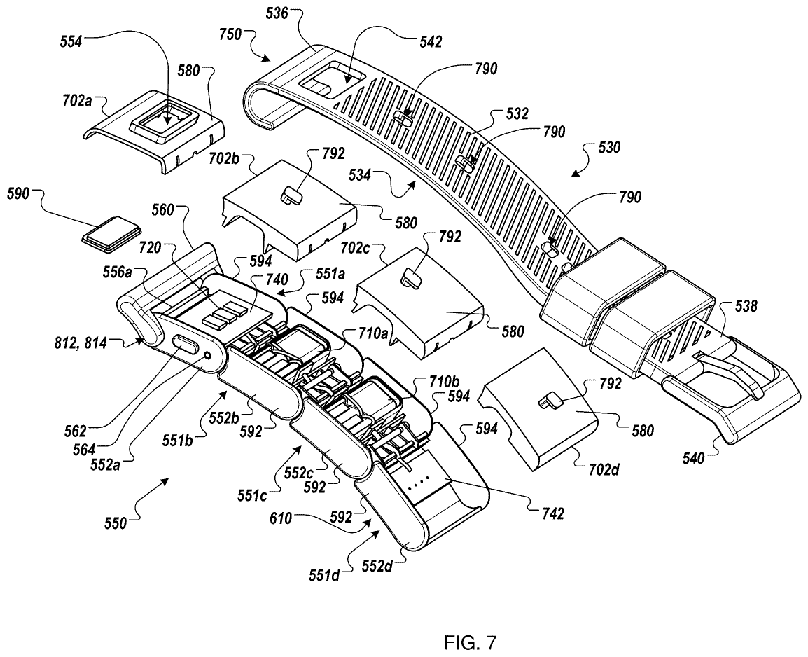

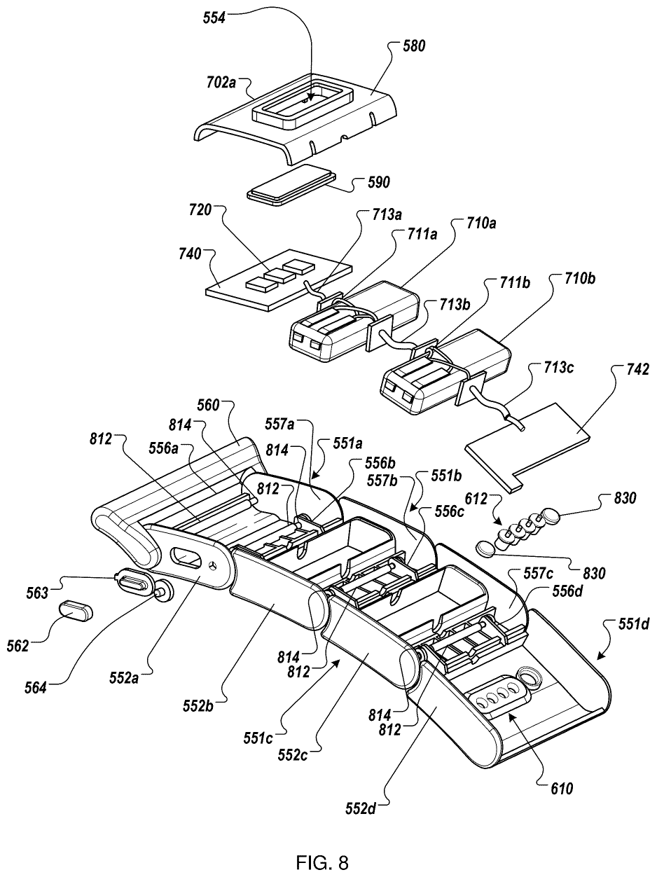

FIG. 6 shows a perspective rear view of the example portable lighting accessory apparatus 500. The link 551d includes a charging interface 610 having a collection of electrically conductive contacts 612. In operation, a power interface (not shown) can be electrically coupled to the charging interface 610 to provide powering the electronics assembly 550 or for recharging rechargeable batteries (which will be discussed further in the description of FIGS. 7 and 8) within the electronics assembly 550.

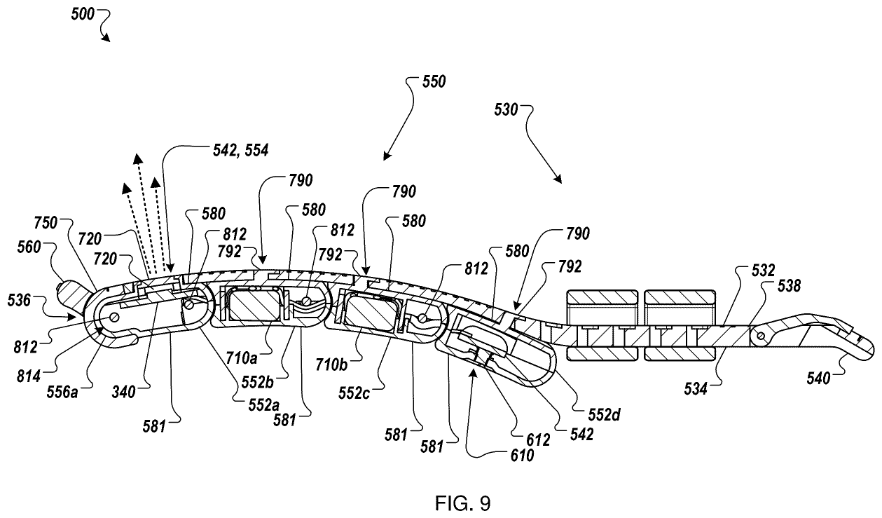

FIGS. 7 and 8 show partly exploded perspective views of the wristwatch band section 530 and the electronics assembly 550 of the example portable lighting accessory apparatus 500. In the illustrated examples, each of the links 551a-551d is shown with a corresponding housing section 702a, 702b, 702c, and 702d opened. FIG. 9 shows a sectional side view of the watch band section 530 and the example portable lighting accessory apparatus 500 taken along section line B-B of FIG. 5.

Each of the housings 552a-552d is a semi-rectangular housing having an outer major housing face 580, with the outer major housing face 580 of the link 551a defining the housing aperture 554. The substantially transparent window 590 is configured to be arranged within the housing aperture 554, and can be made from glass, polycarbonate, or any other appropriate substantially transparent material. In some embodiments, the transparent window 590 can be adhered to or sealed against the housing 552a about the housing aperture 554. In some embodiments, the housings 552a-552d can include seals, gaskets, welds, epoxies, or combinations of these and any other appropriate sealing means to make the electronics assembly 550 resistant to incursion by liquids or debris (e.g., water resistant, waterproof, providing a standard level of environmental protection, such as IP65, IP67, or IP68).

The link 551a includes a light source 720 (e.g., an LED, SMD light, COB light) arranged within the housing 552a proximal to the housing aperture 554. In their assembled form, the light source 720 is configured to emit light through the housing aperture 554 and the window 590 to emit light from the light source 720 substantially perpendicular to the outer major housing face 580 of the link 551a (e.g., and the wearer's wrist) to provide illumination. Also arranged within the link 551a is an electrical circuit 740 in electrical communication with the light source 720, the button 562, and the indicator 564.

The wristwatch coupler assembly 560 is hingedly affixed to the housing end 556a of the housing 552a by a pin 812 and a barrel 814 defined in the housing end 556a, to form a pivotable hinge assembly that permits the housing 552a to move relative to the wristwatch coupler assembly 560 and the wristwatch 10. The wristwatch coupler assembly 560 is configured to adapt the portable lighting accessory apparatus 500 to the wristwatch 10. As such, the wristwatch coupler assembly 560 may be configured with a variety of different shapes and couplers that are complimentary to various wristwatch manufacturers'various makes and models of wristwatches. In the illustrated example, the wristwatch 10 includes a lateral bore having an axial slot, and the wristwatch coupler assembly 560 is defined with a cylindrical bulge that can be slipped laterally into the bore such that the wristwatch coupler assembly 560 extends away from the wristwatch 10 through the axial slot. In some embodiments, the wristwatch coupler assembly 560 can include a spring bar configured to be removably assembled to corresponding lugs of the wristwatch 10. In some embodiments, the wristwatch coupler assembly 560 can include a coupler mechanism, clasp, magnet, fastener, hook, dovetail, or any other form of connection structure that is appropriate for removably affixing watch bands to various brands and models of wristwatches, smartwatches, and other wrist-worn devices and accessories (e.g., Apple Watch Band Interface connection, Garmin watches'Quick Release system, Samsung Galaxy Watch models with spring bar attachment system, Google Fitbit and Pixel Watch models with spring-loaded pin mechanisms).

The link 551b includes a battery 710a and an electrical circuit 711a, and the link 551c includes a battery 710b and an electrical circuit 711b. The electrical circuit 740 is configured to receive power from the batteries 710a and 710b through the electrical circuits 711a and 711b.

A housing end 556b of the link 551b is hingedly affixed to a housing end 557a of the link 551a by a pin 812 and a barrel 814 defined in the housing end 556a, to form a pivotable hinge assembly that permits the housing 552b to move relative to the housing 552a. An interlink circuit 713a electrically connects the electrical circuit 740 to the electrical circuit 711a.

A housing end 556c of the link 551c is hingedly affixed to the housing end 557b by a pin 812 and a barrel 814 defined in the housing end 556b, to form a pivotable hinge assembly that permits the housing 552c to move relative to the housing 552b. An interlink circuit 713b electrically connects the electrical circuit 711b to the electrical circuit 711a. In some embodiments, the batteries 710a and 710b can be polymer batteries rated for about 3.7V at about 30 mAh or more each.

The link 551d includes the collection of electrically conductive contacts 612 that are exposed at the charging interface 610. The electrically conductive contacts 612 are in electrical communication with an electronic battery charger circuit 742 configured to charge the batteries 710a and 710b based on electrical power received at the electrically conductive contacts 612 of the charging interface 610. In some embodiments, the electronic battery charger circuit 742 may be configured to charge the batteries 710a and 710b based on other recharging techniques.

For example, the electronic battery charger circuit 742 can include an inductive charging antenna and be configured to recharge the batteries 710a and 710b using power received from an inductive charging coil (e.g., a wireless charger). In another example, the electronic battery charger circuit 742 can be configured for kinetic charging, in which kinetic energy (e.g., movement of the wearer's wrist) can be converted into electrical energy that can be stored in the batteries 710a and 710b. In yet another example, the electronic battery charger circuit 742 can be configured to receive electrical energy from a photovoltaic cell (e.g., solar panel) or other form photo-electrical conversion apparatus arranged on the portable lighting accessory apparatus 500 (e.g., in one or more of the links 551a-551d, in one or both of the wristwatch band sections 510 and 530). In yet another example, the electronic battery charger circuit 742 can include a thermoelectric generator configured to convert the user's body heat into electrical power to recharge the batteries 710a and 710b. In yet another example, the electrically conductive contacts 612 can be configured as a plug or socket (e.g., a USB-C charging receptacle). In the illustrated example, the batteries 710a and 710b are rechargeable batteries, but in some embodiments the batteries 710a and 710b may be non-rechargeable (e.g., replaceable, disposable) batteries.

The link 551d includes a collection of magnets 830 arranged proximal to the collection of electrically conductive contacts 612 and the charging interface 610. In use, the magnets 830 help to align and removably couple (e.g., snap into place) the electrically conductive contacts 612 to a power interface (not shown) having complementary magnets or magnetic components and configured to provide power for recharging the batteries 710a and 710b.

A housing end 556d of the link 551d is hingedly affixed to the housing end 557c by a pin 812 and a barrel 814 defined in the housing end 556c, to form a pivotable hinge assembly that permits the housing 552d to move relative to the housing 552c. An interlink circuit 713c electrically connects the electronic battery charger circuit 742 to the electrical circuit 711b.

The electrical circuit 740 is configured to detect user input (e.g., presses) of the button 562 to control the flow of power from the batteries 710a-710b to the light source 720 to provide illumination. The electrical circuit 740 can be configured to respond to user input at the button 562 to control various operational states of the light source 720, such as to turn the light source 720 on and off, to select brightness modes (e.g., high, medium, low), flashing or strobing effects, color temperature and/or hue (e.g., red mode), or combinations of these or any other appropriate light setting. In some embodiments, the electrical circuit 740 can be configured to recognize different durations and patterns of button presses as different user commands. For example, a long press can be used to turn the light on and off, and short presses can cycle the light among full (e.g., 100%), high (e.g., ~75%), medium (e.g., ~50%), and low (e.g., ~25%) brightnesses. In some embodiments, the light source 720 can provide between 1 and 1000 lumens, or between 1 and 600 lumens, or between 1 and 100 lumens, or between 1 and 60 lumens. In another example, the button 562 can be pressed to switch the light into a red (e.g., low light, low glare) mode having one or more brightness levels. A seal 563 prevents incursion of liquid and/or debris into the link 551a.

In some embodiments, power consumption by the light source 720 can be substantially proportional or related to the selectable brightness level, in which lower brightnesses may be selected to provide longer durations of illumination, while higher brightness levels may be selected to provide additional illumination in exchange for shorter runtimes. For example, the electronics assembly 550 can be configured to operate in a 100% brightness output mode (e.g., about 50-100 Lumens) for about 1 hour and 15 minutes, operate in a 75% brightness mode (e.g., about 35-50 Lumens) for about 1 hour and 30 minutes, operate in a 50% brightness mode (e.g., about 20-35 Lumens) for about 2 hours and 30 minutes, operated in a 25% brightness mode (e.g., about 5-20 Lumens) for about 5 hours, operate in a red light mode (e.g., illuminate red at about 5 -15 Lumens) for about 12 hours, and/or operate in a strobe mode (e.g., flash with a brightness of about 50-70 Lumens) for about 2 hours. Since the electronics assembly 550 is electrically independent from the wristwatch 10, use of the light source 720 that exhausts the batteries 710a-710b will have substantially no effect on the battery of wristwatch 10 (if present). Furthermore, since the electronics assembly 550 is electrically independent from the wristwatch 10, the example portable lighting accessory apparatus 500 can be used with mechanical wristwatches as well as electronic wristwatches.

The electrical circuit 740 is also configured to illuminate the indicator 564, for example, to convey operational status information about the portable lighting accessory apparatus 500, such as on/off status, battery status, charging status, or combinations of these and any other appropriate status information for the electrical circuit 740. For example, the indicator 564 can be controlled to illuminate green when the capacity of the batteries 710a-710b is between 100% and 66%, illuminate yellow from 65% down to 34%, and illuminate red between 33% and 1%.

The wristwatch band section 530 is configured to be overlaid upon the housings 552a-552d, such that the inner major band face 534 opposite the outer major band face 532 is layered upon the outer major housing faces 580. When the wristwatch band section 530 is overlaid upon the housings 552a-552d, the band aperture 542 is substantially aligned with the housing aperture 554 and the transparent window 590. In some embodiments, the transparent window 590 may extend radially away from the housing aperture 554 and extend at least partly into or through the band aperture 542.

The wristwatch band section 530 includes a curvilinear coupler 750 at the end 536 and has a shape that is complementary to the outer shape of the end 536. The curvilinear coupler 750 is configured as a flat hook (e.g., having a form like an extruded J-shape) to partly wrap over a portion of the end 536.

The wristwatch band section 530 includes a collection of apertures 790, and the outer major housing faces 580 of the links 551b-551d each include a retainer hook 792. The retainer hooks are oriented away from the coupler 750. The wristwatch band section 530 is attachable to the electronics assembly 550 by hooking the coupler 750 over the end 536. The wristwatch band section 530 is stretched slightly such that the retainer hooks 792 align with the apertures, and then the wristwatch band section 530 is brought into contact with the outer major housing faces 580 such that the retainer hooks 792 pass through the apertures 790. Tension on the wristwatch band section 530 can then be released, causing the retainer hooks to engage the wristwatch band section 530 as the wristwatch band section 530 is relaxed to prevent the coupler 750 from moving away from and disengaging itself from the end 536. Removal of the wristwatch band section 530 is a reverse of this process, in which the wristwatch band section 530 is stretched slightly to disengage the retainer hooks 792 so they can escape the apertures 790, the wristwatch band section 530 is then peeled away from the electronics assembly 550, and then the coupler 750 is unhooked from the end 536.

In some embodiments, the wristwatch band sections 110 and 530 can be user replaceable. For example, the wristwatch band section 530 can be separated from the electronics assembly 550 and exchanged for a replacement wristwatch band section 530 due to wear. In another example, the wristwatch band sections 110 and 530 can be removable to enable the wearer to easily change the appearance of the portable lighting accessory apparatus 500, such as by having a nylon or silicone watch band to wear for workouts, a leather band to wear for work, and a gold-plated band to wear for formal events.

As best shown in FIG. 9, the outer major housing faces 580 are configured as flat or curvilinear outer faces, and the housings 552a-552d have inner major housing faces 581 configured as flat or curvilinear inner faces opposite the outer major housing faces 580. Referring again to FIG. 5, a lateral face 592 extends substantially from the inner major housing face 581 to the outer major housing face 580, and another lateral face 594 extends substantially from the inner major housing face 581 to the outer major housing face 580 opposite the lateral face 592. In general, the housings 552a-552d, collectively, have a curvature that compliments the natural shape of a human wrist and swings radially relative to the wristwatch 10 such that the electronics assembly can partly conform to the shape and size of the wearer to provide a comfortable fit and a sleek appearance when worn. The interchangeability provided by the wristwatch band sections 110 and 530 can further enhance the comfort and appearance of the portable lighting accessory apparatus 500 by enabling the user to change the look and feel of the wristwatch band sections 110 and 530 as desired.

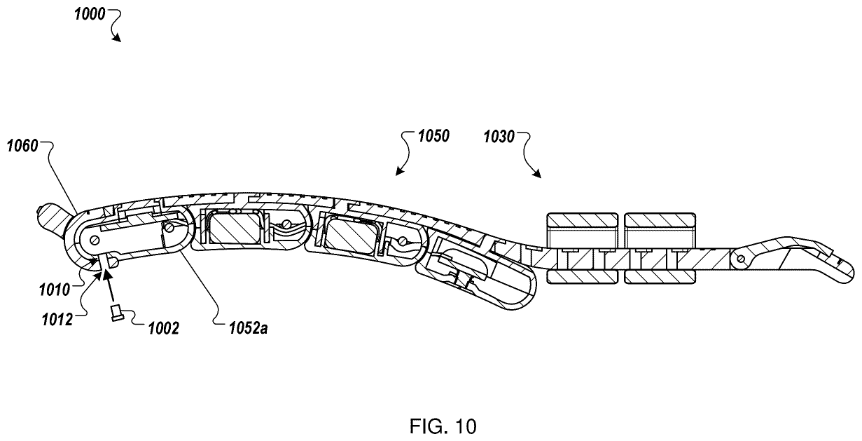

FIG. 10 shows a sectional side view of another embodiment of an example portable lighting accessory apparatus 1000. In general, the portable lighting accessory apparatus 1000 is substantially similar to the portable lighting accessory apparatus 500, but a housing 1052a of an electronics assembly 1050 (substantially similar to the housing 552a of the electronics assembly 550) includes one or more threaded bores 1010, and a coupler 1060 of a watch band section 1030 (e.g., substantially similar to the example coupler 750 and the watch band section 530) includes one or more band bores 1012 defined therethrough. When the coupler 1060 is hooked onto the housing 1052a, the band bores 1012 align with the threaded bores 1010, and a collection of fasteners 1002 (e.g., screws) are passed through the band bores 1012 and then threaded into the threaded bores 1010 to removably or permanently affix the watch band section 1030 to the housing 1052a.

The example embodiments of the portable lighting accessory apparatuses 100, 500 and 1000 are depicted and described as having one or four links, but other embodiments can include other numbers of links, with the internal componentry arranged and distributed among the links in any appropriate configuration. For example, the electronics assembly 550 can be modified to have only a single battery in a single link (e.g., no link 551c, three links total), or it may can be modified to have additional battery links (e.g., three, four, or more links that are similar to the links 551b and/or 551c). In another example, the electronics assembly 150 can be modified by adding a battery link (e.g., similar to the link 551c). In another example, the charging interface 610, the electronic battery charger circuit 742, and or one or both of the batteries 710a-710b can be relocated to a different link (e.g., link 551a). In some embodiments, the links 551a-551d can be re-arranged and/or repurposed in any appropriate configuration (e.g., the charging link such as the link 551d could be linked directly to the link 551a, or it could be configured as the first link connected to the wristwatch 10, with other links similar to the links 551b-551d extending the assembly away from the wristwatch 10).

The description above describes the portable electronic accessory apparatus primarily in the context of a flashlight accessory. However, embodiments of the portable electronic accessory apparatus are not limited to flashlights and can be configured with other and/or additional features and/or functions.

In some embodiments, the portable electronic accessory apparatus can be a personal safety alarm apparatus. For example, the portable electronic accessory apparatus can include an audio emitter (e.g., speaker, piezoelectric element) that a user can trigger to emit an alarm or siren (e.g., up to 135 decibels) that may help repel a threat or attract help. The portable electronic accessory apparatus can include various triggering features, such as an activation button, a countdown timer, a microphone, or an accelerometer. For example, the portable electronic accessory apparatus can be configured to trigger the alarm in response to a predetermined pattern of button presses, a predetermined gesture (e.g., vigorous prolonged shaking of the wrist), and/or a predetermined trigger word or sound. The portable electronic accessory apparatus can also include location detection features (e.g., global positioning system receiver). The portable electronic accessory apparatus can also include communications features that can communicate with the watch. For example, the portable electronic accessory apparatus can include a Bluetooth module that is paired with a smartwatch or smartphone, and when triggered, the portable electronic accessory apparatus can communicate with the paired device to activate a function of the paired device (e.g., activate a software application that can summon the police or other help).

In some embodiments, the portable electronic accessory apparatus can be a portable computing device. For example, the portable electronic accessory can include a processor, memory, communications, and/or input/output devices such that it can be used to add “smart” watch functionality to a conventional (e.g., non “smart”) watch.

In some embodiments, the portable electronic accessory apparatus can be a portable communication device. For example, the portable electronic accessory apparatus can include cellular communications hardware, a Bluetooth transceiver, a Family Radio Service (FRS) transceiver, or any other appropriate type of communication system that can be used to add telephone or two-way radio functionality to a wristwatch.

In some embodiments, the portable electronic accessory apparatus can be a personal safety alarm apparatus for hikers or outdoorspeople. For example, the portable electronic accessory apparatus can include an audio emitter (e.g., speaker, piezoelectric element) that a user can trigger to emit an alarm or siren (e.g., up to 135 decibels) that may help repel wildlife (e.g., a bear horn) or attract help (e.g., audible locator beacon when lost in the woods, avalanche beacon).

In some embodiments, the portable electronic accessory apparatus can be a personal horn. For example, the apparatus could be configured to produce a sound up to about 100 decibels, and could be used by cyclists, runners, or hikers to safely alert others when passing on trails or in parks, reducing the risk of accidents (e.g., like a bike bell).

In some embodiments, the portable electronic accessory apparatus can include a recharging apparatus (e.g., charging cradle or dock). For example, the recharging apparatus can be configured to provide charging for the portable electronic accessory apparatus (e.g., providing power at pins of a charging pad or connector that is compatible with the charging interfaces 210 or 610 of the example electronic assemblies 150 and 550) as well as providing charging for the wristwatch (e.g., providing power at pins or a charging pad, connector, or inductive antenna that is compatible with the wristwatch). In some embodiments, the recharging apparatus can be configured to orient and align the wristwatch and the portable electronic assembly with their respective charging inputs. For example, the recharging apparatus can be configured as a cradle having a shape that compliments the shape of the assembled wristwatch and portable electronic accessory, such that when the user rests the assembly in the cradle, the cradle guides the wristwatch and the portable electronic accessory into alignment and/or contact with their respective chargers in a single, convenient action.

In some embodiments, the example portable lighting accessory apparatuses 100, 500, and/or 1000 can include computing or processing features (e.g., for communication, geolocation, input sensing). As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the apparatuses discussed above are not limited to the exact details of construction, operation, exact materials, or embodiments shown and described, as obvious modifications and equivalents will be apparent to one skilled in the art. While the specific embodiments have been illustrated and described, numerous modifications come to mind without significantly departing from the spirit of the disclosure, and the scope of protection is only limited by the scope of the accompanying Claims. It should also be understood that substantially utilized herein means a deviation that is less than 15% and preferably less than 5%. It should also be understood that other configuration or arrangements of the above-described components is contemplated by this Application.

In this patent, to the extent any U.S. patents, U.S. patent applications, or other materials (e.g., articles) have been incorporated by reference, the text of such materials is only incorporated by reference to the extent that it does not directly conflict with materials or statements set forth in this Application. In the event of such a direct conflict exists, the text of the present document governs. However, the terms contained in this document should not be given a narrower reading in virtue of the way in which those terms are used in other materials incorporated by reference.

1. A portable lighting accessory apparatus for a wristwatch, comprising:
a first wristwatch band section configured to be removably affixed to a wristwatch main body at a first band end and extending to a second band end opposite the first band end;
a lighting assembly comprising:
a first housing having a first housing end configured to be removably affixed to the wristwatch main body and having an outer major housing face defining a housing aperture;
a battery;
a light source arranged within the first housing proximal to the housing aperture, the light source configured to emit light through the housing aperture to provide illumination; and
a first electrical circuit in electrical communication with the battery and the light source; and
a second wristwatch band section configured to be removably affixed to the first housing end of the first housing at a third band end and extending to a fourth band end opposite the third band end, the second wristwatch band section having:
an outer major band face;
an inner major band face opposite the outer major band face and configured to be positioned against the outer major housing face of the first housing; and
a band aperture that: extends from the inner major band face to the outer major band face, is arranged proximal to the housing aperture, and is configured to permit light emitted by the light source to be emitted through the band aperture to provide illumination beyond the second wristwatch band section.

2. The portable lighting accessory apparatus of claim 1, wherein the lighting assembly is configured to emit light from the light source substantially perpendicular to the outer major housing face of the first housing.

3. The portable lighting accessory apparatus of claim 1, further comprising a substantially transparent window arranged in one of the housing aperture or a portion of the band aperture.

4. The portable lighting accessory apparatus of claim 1, wherein the lighting assembly includes a wristwatch coupler assembly affixed to the first housing end of the first housing and configured to be removably affixed to the wristwatch main body.

5. The portable lighting accessory apparatus of claim 1, wherein the lighting assembly further comprises:
a charging interface comprising a plurality of electrically conductive contacts; and
an electronic battery charger circuit arranged in electrical communication with the charging interface,
wherein the battery is a rechargeable battery, and the electronic battery charger circuit is configured to charge the rechargeable battery based on electrical power received at the charging interface.

6. The portable lighting accessory apparatus of claim 1, wherein the first housing is configured to include the battery and the first electrical circuit.

7. The portable lighting accessory apparatus of claim 6, wherein the outer major housing face has a curvilinear configuration, and the first housing has an inner major housing face with a curvilinear configuration.

8. The portable lighting accessory apparatus of claim 1, further comprising:
a second housing pivotably affixed to a second housing end of the first housing opposite the first housing end, the second housing including a second electrical circuit in electrical communication with the first electrical circuit;
a third housing pivotably affixed to the second housing, the third housing including a third electrical circuit in electrical communication with the second electrical circuit; and
an electronic battery charger circuit configured to charge the battery and arranged in one of the second housing or the third housing, wherein the battery is a rechargeable battery.

9. The portable lighting accessory apparatus of claim 8, further comprising a charging interface including a plurality of electrically conductive contacts arranged on one of the first housing, the second housing, or the third housing, and,
wherein the electronic battery charger circuit is configured to charge the battery based on electrical power received at the charging interface.

10. The portable lighting accessory apparatus of claim 1, wherein the second wristwatch band section further comprises a curvilinear coupler at the third band end and configured to partly surround the first housing end.

11. The portable lighting accessory apparatus of claim 1, wherein the first housing has at least one housing bore defined therein, and the second wristwatch band section has at least one band bore defined therein and arranged to overlap and align with the housing bore, and the second wristwatch band section further comprises at least one fastener arranged to extend through the band bore and engage the housing bore.

12. A portable lighting accessory apparatus for a wristwatch, comprising:
a first wristwatch band section configured to be removably affixed to a wristwatch main body at a first band end and extending to a second band end opposite the first band end;
a lighting assembly comprising:
a first link having a first housing adapted to be operatively coupled to the wristwatch main body at a first housing end and having: (i) a first outer major housing face defining a housing aperture and a first inner major housing face opposite the first outer major housing face, (ii) a light source arranged within the first housing proximal to the housing aperture, the light source configured to emit light through the housing aperture to provide illumination, and (iii) a first electrical circuit arranged within the first housing in electrical communication with the light source;
a second link operatively coupled to the first link and having a second housing with: (i) a rechargeable battery and (ii) a second electrical circuit arranged at least partly within the second housing and in electrical communication with the rechargeable battery and the first electrical circuit;
a third link operatively coupled to the second link and having a third housing with: (i) an electronic battery charger circuit configured to charge the rechargeable battery, (ii) a charging interface, and (iii) a third electrical circuit in electrical communication with the charging interface, the electronic battery charger circuit, and the rechargeable battery; and
a second wristwatch band section configured to be removably affixed to the first housing end at a third band end and extending to a fourth band end opposite the third band end, the second wristwatch band section having:
an outer major band face;
an inner major band face opposite the outer major band face and configured to reside against the first housing; and
a band aperture that: extends from the inner major band face to the outer major band face, is arranged proximal to the housing aperture, and is configured to permit light emitted by the light source to pass through the band aperture to provide illumination beyond the second wristwatch band section.

13. The portable lighting accessory apparatus of claim 12, wherein the lighting assembly is configured to emit light from the light source substantially perpendicular to the first outer major housing face of the first housing.

14. The portable lighting accessory apparatus of claim 12, further comprising a substantially transparent window arranged in one of the housing aperture or a portion of the band aperture.

15. The portable lighting accessory apparatus of claim 12, wherein the lighting assembly includes a wristwatch coupler assembly affixed to the first housing end of the first housing and configured to be removably affixed to the wristwatch main body.

16. The portable lighting accessory apparatus of claim 12, wherein:
the first outer major housing face is configured as a curvilinear outer face; and,
the first inner major housing face is configured as a curvilinear inner face.

17. The portable lighting accessory apparatus of claim 12, wherein the charging interface comprises a plurality of electrically conductive contacts arranged on the third housing, wherein the electronic battery charger circuit is configured to charge the rechargeable battery based on electrical power received at the charging interface.

18. The portable lighting accessory apparatus of claim 12, wherein the second wristwatch band section further comprises a curvilinear coupler at the third band end and configured to partly surround the first housing end.

19. The portable lighting accessory apparatus of claim 18, wherein the first housing has at least one housing bore defined therein, and the curvilinear coupler has at least one band bore defined therein and arranged to overlap and align with the housing bore, and the second wristwatch band section further comprises at least one fastener arranged to extend through the band bore and engage the housing bore.

20. The portable lighting accessory apparatus of claim 12, wherein the first housing has at least one housing bore defined therein, and the second wristwatch band section has at least one band bore defined therein and arranged to overlap and align with the housing bore, and the second wristwatch band section further comprises at least one fastener arranged to extend through the band bore and engage the housing bore.
